(19) United States
(12) Patent Application Publication
(10) Pub. No.: US 2007/0031569 A1
(43) Pub. Date: Feb. 8, 2007

(54) Snack foods comprising emulsified liquid shortening compositions

(75) Inventors: Gregory J. Halpern, Vernon Hills, IL (US); Triveni P. Shukla, New Berlin, WI (US)

Correspondence Address: Z Trim Holdings, Inc., 1011 Campus Drive, Mundelein, IL, 60060, US

(73) Assignee: Z Trim Holdings, Inc.

(21) Appl. No.: 11/545,288

(22) Filed: Oct. 10, 2006

Related U.S. Application Data
(63) Continuation-in-part of application No. 10/689,208, filed on Oct. 20, 2003, now abandoned.

(51) Int. Cl. A23L 1/05

(52) U.S. Cl. 426/602; 426/573

(57) ABSTRACT

According to the present invention, fat and caloric content of snack foods can be reduced by the replacement of a portion fat content normally found in snack foods with an amount of emulsified liquid shortening composition comprising dietary fiber gel, water and lipid. The result is that fat and caloric content of snack foods can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of snack foods, further health benefits can be achieved by replacing a portion of fat with emulsified liquid shortening compositions comprising dietary fiber gel, water and lipid.

### CROSS-REFERENCE TO RELATED APPLICATIONS

This application is a Continuation-in-Part Application of U.S. patent application Ser. No. 10/689,208 filed on Oct. 20, 2003, the entirety of which is incorporated herein by reference.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to snack foods comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as snack foods.

Snack foods typically comprise some fat. Other ingredients can vary according to the type of snack food and the recipe followed, but typically, snack foods are high in both fat and caloric content. Snack foods can be divided into two broad classes: salty snack foods, such as chips and crackers, and sweet snack foods, such as candies and snack bars, for example granola bars and nutrition bars.

In recent years, some companies have begun to offer reduced fat snack foods. This variety of snack food, however, often fails to retain the desirable taste and texture of snack foods comprising higher fat contents.

The absence of a means to reduce the fat and caloric content of snack foods while still producing a desirably flavored and textured snack food presents an unmet need in today's food industry.

### BRIEF SUMMARY OF THE INVENTION

It is an object of the present invention to provide a unique composition of matter embodied by low-calorie and low-fat snack foods. This reduction in caloric and fat content answers an unmet need in the food industry to provide the consuming public with a healthier, higher fiber alternative to traditional types of snack foods that typically are inherently fattening. It is another object of the present invention to provide snack foods that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. Additionally, these dietary fiber gels are characterized by their high viscosity at low solid levels. Other insoluble fibers derived from cereals, grains and legumes consist of morphologically intact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations. A physically smooth morphology is readily revealed under electron microscopic magnification of amorphous insoluble cellulosic gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

More specifically, the present invention utilizes emulsified mixtures of the dietary fiber gels disclosed in the '662 patent, the emulsified mixtures further comprising, at a minimum, water and lipid. These emulsified mixtures are fully described in and are the subject of U.S. patent application Ser. No. 10/669,731 filed Sep. 24, 2003, which is herein incorporated by reference in its entirety. These emulsified mixtures are fully described in and are the subject of U.S. patent application Ser. No. 10/669,731 filed Sep. 24, 2003, which is incorporated by reference in its entirety herein. The ingredients of emulsified mixtures include dietary fiber gel, water, and lipid. The lipid can be any oleic fatty acids, flax seed oil, olive oil, canola oil, corn oil, walnut oil, peanut oil, and any other vegetable oil, and any combination of these oils. The ingredient quantities on a total weight basis of 100 parts are preferably a range of 30 to 80 parts water, 0.3 to 20 parts dietary fiber gel solids, and a balance of lipid and other optional components. The ingredients are combined and mixed, and the mixture is subjected to high shear micro-particulation such as by homogenization, colloid milling, ultrasonication treatment, and so forth. For example, dietary fiber gel, water, and lipid can be combined, mixed, and then homogenized at a pressure of between 1500 to 2500 pounds per square inch and temperatures in the range of 120 to 195 degrees Fahrenheit.

These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of snack foods, further health benefits can be achieved by replacing a portion of fat with emulsified liquid shortening compositions comprising dietary fiber gel, water and lipid.

According to the present invention, fat and caloric content can be reduced by the replacement of the fat normally found in snack foods with emulsified liquid shortening compositions comprising dietary fiber gel, water and lipid. This replacement of fat does not adversely affect either the taste or texture of the snack foods. The result is that fat and caloric content of snack foods can be manipulated with minimal effect on taste and texture, and as stated above, additional health benefits can be achieved through consumption of snack foods comprising emulsified liquid shortening compositions comprising dietary fiber gel, water and lipid when functional foods are included in the formulations.

Further objects, advantages and features of the present invention will present themselves in the following detailed description.

### DETAILED DESCRIPTION OF THE PREFERRED EMBODIMENT

This invention is directed to snack foods comprising emulsified liquid shortening compositions comprising dietary fiber gel, water and lipid. According to the present invention, fat and caloric content can be reduced by the replacement of the fat normally found in snack foods with emulsified liquid shortening compositions comprising dietary fiber gel, water and lipid (hereinafter “emulsified liquid shortening”). This replacement of fat does not adversely affect either the taste or texture of the snack foods. The result is that fat and caloric content of snack foods can be manipulated with minimal effect on taste and texture.

Salty snack foods, for example crackers and chips, can be formulated such that the snack food comprises 0.1 percent to 5.0 percent dietary fiber gel solids by replacing an appropriate amount, that is, an amount prorated to deliver this range of dietary fiber gel solids, of fat, including oil and liquid shortening, with an essentially identical amount of emulsified liquid shortening. Sweet snack foods, for example candies and nutrition bars, can be formulated such that the snack food comprises 0.1 percent to 5.0 percent dietary fiber gel solids by replacing an appropriate amount, that is, an amount prorated to deliver this range of dietary fiber gel solids, of fat, including oil and liquid shortening, with an essentially identical amount of emulsified liquid shortening.

The result is that fat and caloric content of snack foods can be manipulated with minimal effect on taste and texture, and as stated above, additional health benefits can be achieved through consumption of snack foods comprising emulsified liquid shortening compositions comprising dietary fiber gel, water and lipid when functional foods are included in the formulations.

### EXAMPLES

BASIC EMULSION (Emulsified Liquid Shortening)

| Ingredients | Percent | Preparation/Remarks |
|---|---|---|
| Water | 88.50 | 1. Blend at highest possible |
| | | speed Ztrim powder |
| | | in water to produce |
| | | a creamy gel |
| Dietary Fiber | 4.00 | |
| Gel Powder | | |
| High Omega Canola | 7.50 | 2. Add oil or oily pastes |
| Oil | | (almond, sesame seed) |
| | | and blend well at low speed |
| Flavor and color as | | |
| desired specific to a | | |
| product type | | |

### Example 1

### Cheese Cracker

| | | W/ | |
|---|---|---|---|
| Ingredients | CONTROL | EMULSION | Preparation/Remarks |
| Cheese Cracker | PARTS | PARTS | |
| Sponge Ingredients | | | |
| Flour | 75.00 | 75.00 | |
| Yeast | 0.30 | 0.30 | |
| Cheddar Cheese | 10.00 | 10.00 | 1. 18 hour sponge |
| | | | fermentation |
| Shortening | 7.50 | — | 2. 2 hour dough |
| | | | fermentation |
| Water | 23.50 | — | 3. Cut/Mold and bake |
| Basic Emulsion | | 31.00 | |
| Dough Ingredients | | | |
| Flour | 23.00 | | |
| Sodium Bicarbonate | 0.45 | | Note: Paprika |
| | | | can be blended |
| | | | into Cheddar cheese |
| Malt Syrup | 1.00 | | |
| Basic Emulsion | | 2.00 | |
| Water | As Required | | |
| Cheddar Cheese | 4.00 | | |
| Salt | 1.00 | | |

### Example 2

### Nutrition Bar

| | | W/ | |
|---|---|---|---|
| Ingredients | CONTROL | EMULSION | Preparation/Remarks |
| SOLIDS | | | |
| Soy Protein Isolate | 15.70 | 12.00 | Solids/Liquid Ratio::44.10/55.90 |
| Calcium Caseinate | 8.60 | 6.00 | 1. Mix all dry ingredients |
| Whey Protein Concentrate | 7.80 | 7.80 | 2. Mix all liquid ingredients |
| Cocoa | 6.60 | | 3. Blend and knead 2 with 1 |
| Beta Glucan Fiber | 2.70 | — | 4. Sheet and cut into 42 gram bars |
| Vitamin and Mineral mix | 1.90 | 1.90 | 5. Coat with chocolate coating |
| Salt | 0.80 | 0.80 | Coat with 10 gram of chocolate Coating |
| LIQUIDS | | | |
| High Fructose Corn Syrup | 25.10 | 25.10 | Bars or chips can be toasted to |
| High Maltose Syrup | 12.10 | 12.10 | A moisture of 2.00% maximum |
| Honey | 7.10 | 7.10 | |
| Unsweetened Chocolate | 2.39 | 2.39 | |
| Canola Oil | 1.90 | 1.90 | |
| Soy Oil | 1.90 | — | |
| Water | 5.00 | — | |
| Basic Emulsion | | 14.00 | |
| Flavor | 0.50 | | |
| | 100.00 | | |

### Example 3

### Granola Bar

| | | W/ | |
|---|---|---|---|
| Ingredients | CONTROL | EMULSION | Preparation/Remarks |
| Granola Bar | | | |
| SOLIDS | | | |
| Rolled Oats | 17.30 | 17.30 | |
| Wheat Germ | 14.30 | 14.30 | 1. Dry blend ingredients under “solids” |
| Corn Bran, Refined | 6.00 | 3.00 | 2. Add ingredients under “liquids” |
| Coconut | 8.90 | 8.90 | 3. Mix, lightly consolidate, and mold |
| Raisins | 7.50 | 7.50 | 4. Bake at 325 Deg F for 25 minutes |
| Almonds | 9.10 | 9.10 | 5. Cut and cool |
| LIQUIDS | | | |
| Honey | 8.30 | 8.30 | |
| Brown Sugar | 7.60 | 7.60 | |
| Corn Syrup | 7.50 | 7.50 | |
| Canola Oil | 4.50 | 4.50 | |
| Water | 7.50 | 7.50 | |
| Basic emulsion | | 7.50 | |
| Vanilla | 1.50 | 1.50 | |
| | 100.00 | 100.00 | |

### Example 4

### Jelly Beans

| | | W/ | |
|---|---|---|---|
| Ingredients | CONTROL | EMULSION | Preparation/Remarks |
| Jelly Beans | | | CENTER |
| Corn Syrup, 42 D.E./43 Be | 54.06 | 54.06 | 1. Add syrup, water/Basic emulsion, |
| Sugar | 23.17 | 23.17 | and starch in a double agitator/kettle. |
| Thin Boiling Starch, 65 | 5.17 | 5.17 | 2. After starch is dispersed, add sugar |
| Fluidity | | | |
| High Amylose Starch | 3.47 | 3.47 | 3. Bring to rolling boil and terminate |
| Water | 14.13 | | heating |
| Basic emulsion | | 14.13 | |
| | 100.00 | | 4. Injection cook at 340 Deg F. |
| Engrossing Syrup | | | 5. Catch in another kettle. |
| Corn Syrup | 65.00 | 65.00 | 6. Add flavor Color, pump to depositor Tank |
| Maltodextrin | 4.00 | 4.00 | 7. Transfer beans to drays |
| Sugar | 18 | 18 | 8. Dry at 160 Deg F and then cool |
| water | 13 | 6.50 | (Center moisture around 17.5%) |
| Basic Emulsion | | 6.50 | ENGROSSING |
| Color, flavor as desired | | | 9. Break lumps in a blend of equal parts of |
| | | | maltodextrin and sugar blend. |
| | | | 10. Make engrossing syrup, 38 Be, 105 |
| | | | Deg F. Use 1 quart Engrossing syrup |
| | | | Per 150 lb center material. |
| | | | 10. add 4.5 lb baker's sugar for drying the |
| | | | centers. |

### Example 5

### Multigrain Chip

| | | W/ | |
|---|---|---|---|
| Ingredients | CONTROL | EMULSION | Preparation/Remarks |
| Multigrain Chip | | | |
| Masa Flour | 45.00 | 45.00 | 1. Blend all dry ingredients in the mixer |
| Whole wheat Flour | 8.00 | 8.00 | 2. Add water or Basic emulsion to mixer |
| Oat Flour | 5.00 | 5.00 | 3. Pre[pare dough |
| Water | 42.00 | — | 4. Sheet and cut on rolls |
| Basic Emulsion | | 42.00 | 5. Bake and Toast |
| | | | 6. Season and salt in a tumbler/sprayer with |
| | | | 4X dilution of emulsion containing spices |

I claim:

1. snack food, the snack food having a formulation, the snack food comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall snack food formulation, and
the emulsified liquid shortening composition comprising dietary fiber gel, water and lipid replaces an amount of fat used in an otherwise identical recipe of snack food that uses no emulsified liquid shortening compositions comprising dietary fiber gel, water and lipid.

2. chips, the chips having a formulation, the chips comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall chips formulation, and
the emulsified liquid shortening composition comprising dietary fiber gel, water and lipid replaces an amount of fat used in an otherwise identical recipe of chips that uses no emulsified liquid shortening compositions comprising dietary fiber gel, water and lipid.

3. crackers, the crackers having a formulation, the crackers comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall crackers formulation, and
the emulsified liquid shortening composition comprising dietary fiber gel, water and lipid replaces an amount of fat used in an otherwise identical recipe of crackers that uses no emulsified liquid shortening compositions comprising dietary fiber gel, water and lipid.

4. candy, the candy having a formulation, the candy comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall candy formulation, and
the emulsified liquid shortening composition comprising dietary fiber gel, water and lipid replaces an amount of fat used in an otherwise identical recipe of candy that uses no emulsified liquid shortening compositions comprising dietary fiber gel, water and lipid.

5. snack bars, the snack bars having a formulation, the snack bars comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall snack bars formulation, and
the emulsified liquid shortening composition comprising dietary fiber gel, water and lipid replaces an amount of fat used in an otherwise identical recipe of snack bars that uses no emulsified liquid shortening compositions comprising dietary fiber gel, water and lipid.

6. granola bars, the snack bars having a formulation, the granola bars comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 5.0 percent by weight of the overall granola bars formulation, and
the emulsified liquid shortening composition comprising dietary fiber gel, water and lipid replaces an amount of fat used in an otherwise identical recipe of granola bars that uses no emulsified liquid shortening compositions comprising dietary fiber gel, water and lipid.
